(19) United States
(12) Patent Application Publication
(10) Pub. No.: US 2011/0188453 A1
(43) Pub. Date: Aug. 4, 2011

(54) BASE STATION, CSG MANAGEMENT SERVER, AND METHOD FOR MANAGING MOBILE TERMINAL

(75) Inventors: Cham A. CHOI, Seoul (KR); Shinhae MO, Gwangmyeong-si (KR)

(73) Assignee: PANTECH CO., LTD., Seoul (KR)

(21) Appl. No.: 13/017,752

(22) Filed: Jan. 31, 2011

(30) Foreign Application Priority Data
Feb. 3, 2010 (KR) 10-2010-0009880

(51) Int. Cl. H04W 88/08; H04W 88/02

(52) U.S. Cl. 370/328

(57) ABSTRACT

Disclosed are a small base station and a method for managing a mobile terminal, and a closed subscriber group (CSG) management server. The small base station may communicate with a server for managing a CSG in which the mobile terminal is registered, and may temporarily delete the mobile terminal from the CSG if the mobile terminal is in a packet data protocol (PDP) preservation state or re-register the temporarily deleted mobile terminal in the CSG.

### CROSS-REFERENCE TO RELATED APPLICATION

This application claims priority from and the benefit under 35 U.S.C. §119(a) of Korean Patent Application No. 10-2010-0009880, filed on Feb. 3, 2010, which is hereby incorporated by reference for all purposes as if fully set forth herein.

### BACKGROUND

1. Field

Exemplary embodiments of the present invention relate to a closed subscriber group (CSG) management server, a small base station, and a method for managing a mobile terminal.

2. Discussion of the Background

A closed subscriber group (CSG) describes access to a small base station among user equipments that are subscribed to a service of a service provider. After a specific user equipment is registered in a CSG, the specific user equipment belongs to the CSG even if the user equipment does not use a network via a small base station. Thus, if a plurality of specific user equipments are not actively using a network but still belong to a CSG, a load is applied to a home subscriber server (HSS). To solve this problem, a solution has been proposed in which a capacity of a server for storing a CSG identification (ID) list or a capacity of a HSS is expanded; however, economical efficiency is not good. Another proposed solution incorporates a function of an HSS into a configuration of a core network; however, this disadvantageously increases a load of the core network and adds a function and defines a new protocol to provide the function of the HSS.

### SUMMARY

Exemplary embodiments of the present invention provide a small base station to manage a mobile terminal, which may reduce a load of a home subscriber server (HSS) or a load of a core network in the case a function of the HSS is incorporated into a configuration of the core network, without incurring any additional costs, and provide a method for managing a mobile terminal by the small base station, and a closed subscriber group (CSG) management server.

Additional features of the invention will be set forth in the description which follows, and in part will be apparent from the description, or may be learned by practice of the invention.

An exemplary embodiment of the present invention provides a small base station to manage a mobile terminal, including: a communication unit to communicate with a server for managing a mobile terminal and a closed subscriber group (CSG) in which the mobile terminal is registered; and a control unit to request the server to temporarily delete the mobile terminal from the CSG or to re-register the temporarily deleted mobile terminal in the CSG.

An exemplary embodiment of the present invention provides a method for managing a mobile terminal by a small base station, including: communicating with a server; and requesting for a temporary deletion of the mobile terminal from a closed subscriber group (CSG) in which the mobile terminal is registered.

An exemplary embodiment of the present invention provides a CSG management server including: a communication unit to communicate with a small base station of a small cell; and a control unit to manage a CSG in which a mobile terminal in the small cell is registered, and to temporarily delete the mobile terminal registered in the CSG or to re-register the temporarily deleted mobile terminal in the CSG in response to a request from the small base station.

An exemplary embodiment of the present invention provides a mobile terminal including a communication unit to communicate with a server for managing a closed subscriber group (CSG) in which the mobile terminal is registered; and a control unit to request the server to temporarily delete the mobile terminal from the CSG or to re-register the temporarily deleted mobile terminal in the CSG.

It is to be understood that both the foregoing general description and the following detailed description are exemplary and explanatory and are intended to provide further explanation of the invention as claimed

Exemplary embodiments of the present invention provide a small base station that is in charge of a part of management of a mobile terminal registered in a closed subscriber group (CSG), for example, deletion or registration of the mobile terminal. For the control of a part of management, the small base station may use a message requesting a management server to delete or register the mobile terminal, and accordingly, a function to delete or register may be implemented by simple addition of a message without extra investment costs.

According to exemplary embodiments of the present invention, in the case a performance of the management server, such as a home subscriber server (HSS), is integrated into a configuration of a core node, deletion or registration of the mobile terminal may be managed by adding such message to the core node, resulting in minimized load of the core node.

According to exemplary embodiments of the present invention, in the case the management server is a server for managing a CSG identification (ID) list, a load caused by an increase in the CSG may be decreased by simple use of a message without additional costs.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a small base station to manage a mobile terminal according to an exemplary embodiment of the present invention.

FIG. 2 is a block diagram illustrating a management server of FIG. 1.

FIG. 3 is a flowchart illustrating a method in which the mobile terminal of FIG. 1 is temporarily deleted from a CSG in which the mobile terminal is registered, in response to a request by the small base station of FIG. 1, according to an exemplary embodiment of the present invention.

FIG. 4 is a flowchart illustrating a method in which the mobile terminal is re-registered in a CSG in response to a request by the small base station according to an exemplary embodiment of the present invention.

FIG. 5 is a flowchart illustrating a method in which the mobile terminal is re-registered in a CSG in response to a request by the small base station, according to an exemplary embodiment of the present invention.

FIG. 6 is a flowchart illustrating a method in which the mobile terminal is deleted from a CSG if a network available time of the mobile terminal expires, in response to a request by the small base station, according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

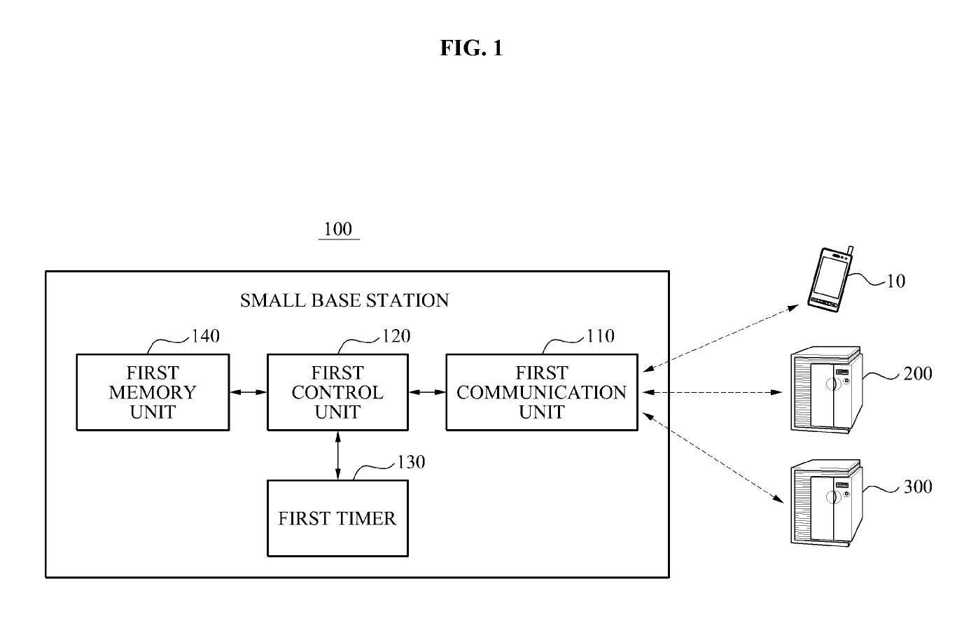

FIG. 1 is a block diagram illustrating a small base station 100 to manage a mobile terminal according to an exemplary embodiment of the present invention. The small base station 100 of FIG. 1 may be installed inside or outside of a macro cell (MC), and may have a coverage of a small cell. The small base station 100 communicates with a mobile terminal 10 placed in the coverage of the small base station 100. The small base station 100 may be, for example, a femto base station. The small cell may be, for example, a femto cell, a pico cell, a Home NodeB, a Home EnB, and the like.

A closed subscriber group (CSG) management server 200 (hereinafter referred to as a ‘management server’) manages a CSG using an identification (ID) list of mobile terminals registered in the CSG. The CSG may be used to manage a list of subscribers accessible to the small cell of the small base station 100. The management server 200 may be a home subscriber server (HSS) or a core node 300. An ID of the mobile terminal 10 is included in the CSG ID list while the mobile terminal 10 acts as a temporary member of the CSG for a specific time.

The core node 300 is a node located in a core network, and may be any one of a mobile management entity (MME), a mobile switching center (MSC), or a serving General Packet Radio Service support node (SGSN). The core node 300 may transmit a paging packet message to the mobile terminal 10 via the small base station 100. The paging packet message may be, for example, a message indicating that the core node 300 has data to be transmitted to the mobile terminal 10 and may be applied to a wired and/or wireless communication network. For example, the wired and/or wireless communication network may include a wideband code division multiple access (WCDMA) scheme; however, the wired and/or wireless communication network need not be limited thereto.

The small base station 100 includes a first communication unit 110, a first control unit 120, a first timer 130, and a first memory unit 140.

The first communication unit 110 may perform a wired and/or wireless communication with the mobile terminal 10, the management server 200, and the core node 300.

The first control unit 120 may request the management server 200 to temporarily delete the mobile terminal 10 from a CSG or to re-register the temporarily deleted mobile terminal 10 in the CSG. In this instance, if the CSG management represents management of a subscriber ID list, the first control unit 120 may request the management server 200 to delete an ID of the mobile terminal 10 from a CSG ID list. Also, the first control unit 120 may request the management server 200 to re-register the ID of the temporarily deleted mobile terminal 10 in the CSG ID list.

The first control unit 120 may inquire whether the mobile terminal 10 currently uses a network, i.e., a data usage amount on the network, by transmitting a radio resource control (RRC) measurement control message to the mobile terminal 10.

If the mobile terminal 10 does not use a network for a specific time, i.e., if a communication data amount via the network is zero, the first control unit 120 may determine that the mobile terminal 10 is in a packet data protocol (PDP) preservation state, and request the management server 200 to temporarily delete the mobile terminal 10 from a CSG. The PDP preservation state may be a state in which the mobile terminal 10 is connected to a CSG or a wireless network but does not send or receive data via the network.

In response to the request of the first control unit 120, the management server 200 may temporarily delete the mobile terminal 10 from the CSG and transmit data about the mobile terminal 10 to the first communication unit 110. The information about the mobile terminal 10 includes a period of time during which registration of the mobile terminal 10 in the CSG remains, i.e., a period of time remaining until a network available time expires.

The first control unit 120 may control the first timer 130 to count down the network available time received from the management server 200. The network available time to be counted may be updated in the first memory unit 140.

If the first control unit 120 receives a request for use of the network by the mobile terminal 10 before the network available time expires, the first control unit 120 may request the management server 200 to re-register the mobile terminal 10 in the CSG. Otherwise, if an external terminal (not shown) or the core node 300 has data to be transmitted to the mobile terminal 10, the first control 120 may request the management server 200 to re-register the mobile terminal 10 in the CSG.

The network available time remaining at the point of time of making a request for re-registration may be stored in the first memory unit 140. Thus, if the first control unit 120 makes a request for re-registration, the first control unit 120 may provide the management server 200 with the counted network available time or the most recently updated network available time in the first memory unit 140.

If the network available time expires, the first control unit 120 may request the management server 200 to completely delete the mobile terminal 10 from the CSG. The management server 200 may then completely delete the mobile terminal 10 from the CSG in response to the request of the first control unit 120, and request the external node to terminate a session created between the mobile terminal 10 and the external node.

Even if the management server 200 does not report that the mobile terminal 10 was completely deleted from the CSG, the first control unit 120 may delete the mobile terminal 10 from a management list stored in the first memory unit 140 as the mobile terminal 10 has already been temporarily deleted by the management server 200.

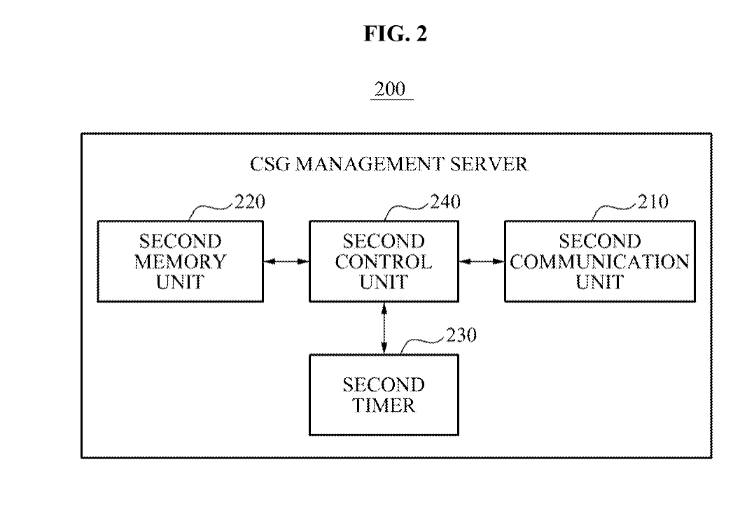

FIG. 2 is a block diagram illustrating the management server 200 of FIG. 1. Referring to FIG. 2, the management server 200 may include a second communication unit 210, a second memory unit 220, a second timer 230, and a second control unit 240.

The second communication unit 210 may make a wired and/or wireless communication with the mobile terminal 10 and the core node 300.

The second memory unit 220 may store a subscriber registered in a CSG, i.e., an ID list of at least one mobile terminal registered in the CSG. If the small base station 100 makes a request for temporary or complete deletion of a mobile terminal (for example, the mobile terminal 10), an ID of the mobile terminal 10 is deleted from the CSG ID list of the second memory unit 220, and the CSG ID list is updated accordingly.

The second timer 230 counts down a network available time assigned to the mobile terminal 10 registered in the CSG.

The second control unit 240 may manage a CSG in which the mobile terminal 10 in a small cell is registered. The CSG management may represent management of an ID list of mobile terminals registered in the CSG. For example, the second control unit 240 may temporarily delete the mobile terminal 10 registered in the CSG in response to a request of the small base station 100. Also, the second control unit 240 may re-register the temporarily deleted mobile terminal 10 in the CSG in response to a request of the small base station 100. In this instance, the temporary deletion or re-registration of the mobile terminal 10 may represent temporary deletion or re-registration of an ID of the mobile terminal 10.

The second control unit 240 may control the second communication unit 210 to report to the mobile terminal 10 that was temporarily deleted from the CSG. Here, the second control unit 240 may also provide the small base station 100 with information about the mobile terminal 10. The information about the mobile terminal 10 includes a network available time remaining for the mobile terminal 10 to use, and the available time may be reported by the second timer 230.

If temporary deletion or re-registration of the mobile terminal 10 fails, the second control unit 240 may report the failure to the small base station 100. Thus, the small base station 100 may make another request for temporary deletion or re-registration.

If the mobile terminal 10 is temporarily deleted from the CSG, the second control unit 240 may enable a session created between the mobile terminal 10 and an external node (not shown) to be maintained. For this purpose, the second control unit 240 does not transmit a message requesting deletion of the mobile terminal 10 to the external node.

If the network available time of the mobile terminal 10 expires, the second control unit 240 enables the session between the mobile terminal 10 and the external node to be terminated by requesting the external node to delete the mobile terminal 10.

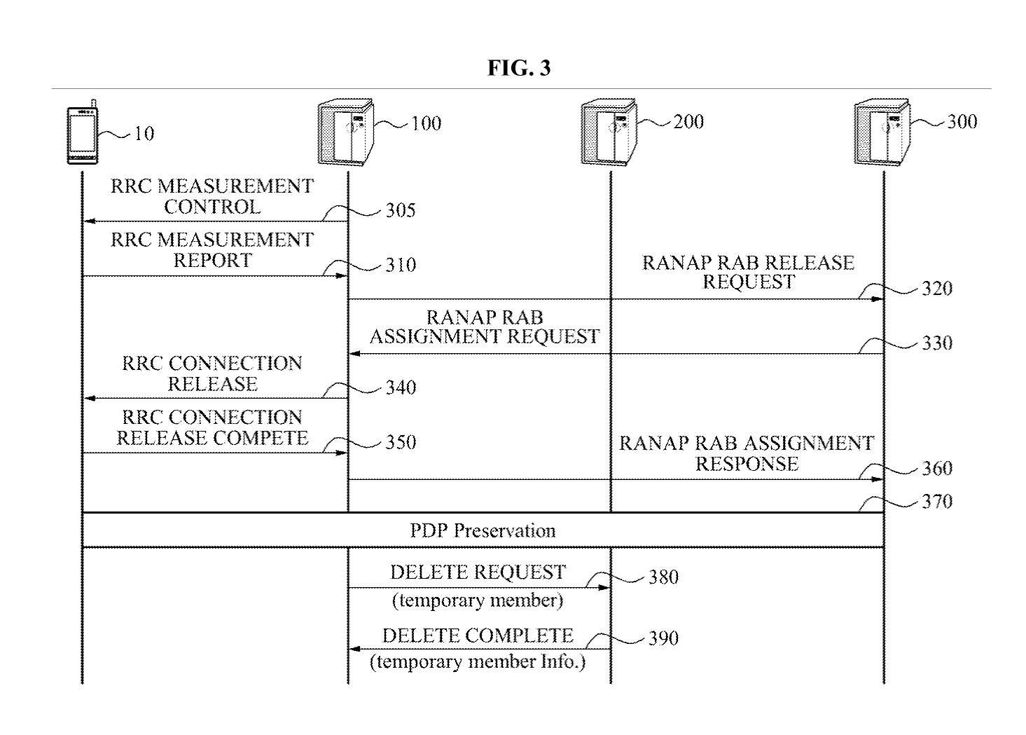

FIGS. 3 through 6 are flowcharts illustrating methods for managing the mobile terminal 10 by the small base station 100 of FIG. 1 according to exemplary embodiments of the present invention.

First, FIG. 3 is a flowchart illustrating a method in which the mobile terminal 10 of FIG. 1 is temporarily deleted from a CSG in which the mobile terminal 10 is registered, in response to a request by the small base station 100, according to an exemplary embodiment of the present invention.

The small base station 100 may inquire about a network usage amount to the mobile terminal 10 by transmitting an RRC MEASUREMENT CONTROL message to the mobile terminal 10 in operation 305.

The small base station 100 may receive an RRC MEASUREMENT REPORT message from the mobile terminal 10 in operation 310. In other words, the mobile terminal 10 may periodically measure a network usage amount, i.e., a current data usage amount on a network, and report the usage amount to the small base station 100 in the RRC MEASUREMENT REPORT in operation 310.

If the analysis result of the RRC MEASUREMENT CONTROL message shows that a network usage amount of the mobile terminal 10 is currently zero, the small base station 100 may transmit an RAB RELEASE REQUEST message to the core node 300 according to a radio bearer release (RBR) procedure in operation 320. The RAB RELEASE REQUEST message may be a Radio Access Network Application Protocol (RANAP)-based message.

The core node 300 may transmit an RAB AASIGNMENT REQUEST message to the small base station 100 based on the RAB RELEASE REQUEST message in operation 330.

The RAB AASIGNMENT REQUEST message may be a RANAP-based message.

The small base station 100 may transmit an RRC CONNECTION RELEASE message to the mobile terminal 10 in operation 340.

The small base station 100 may receive an RRC CONNECTION RELEASE COMPLETE message from the mobile terminal 10 in operation 350.

The small base station 100 may transmit, to the core node 300, a RAB ASSIGNMENT REPONSE message in response to the RAB ASSIGNMENT REQUEST message in operation 360 and thus, the RBR procedure may be completed. The RAB ASSIGNMENT REPONSE message may be a RANAP-based message

As the RBR procedure is completed, the mobile terminal 10 is in a PDP preservation state in operation 370. The PDP preservation state may be a state where a PDP connection is preserved and signaling connection is released.

If the small base station 100 checks whether the mobile terminal 10 is in a PDP preservation state, the small base station 100 may transmit, to the management server 200, a DELETE REQUEST message requesting temporary deletion of the mobile terminal 10 from the CSG in operation 380.

The small base station 100 may receive a DELETE COMPLETE message from the management server 200, indicating that the mobile terminal 10 was temporarily deleted from the CSG in operation 390.

If the management server 200 receives the DELETE REQUEST message in operation 380, the management server 200 may temporarily delete the mobile terminal 10 from the CSG. Also, the management server 200 may allocate information about the mobile terminal 10 stored in the second memory unit 220 for the DELETE COMPLETE message and transmit the information to the small base station 100. The information about the mobile terminal 10 includes a network available time remaining for the mobile terminal 10 to use. The small base station 100 enables the first memory unit 140 to store the information about the mobile terminal 10 and operates the first timer 130 to manage the network available time.

If the small base station 100 does not receive the DELETE COMPLETE message within a predetermined time, or if the small base station 100 receives, from the management server 200, a message indicating that the temporary deletion has failed, which indicates that the mobile terminal 10 was not deleted from the CSG, the mobile terminal 10 may be deleted from the CSG if a an amount of time, i.e., a network available time, expires. Alternatively, the small base station 100 may request the management server 200 for temporary deletion of the mobile terminal 10 again.

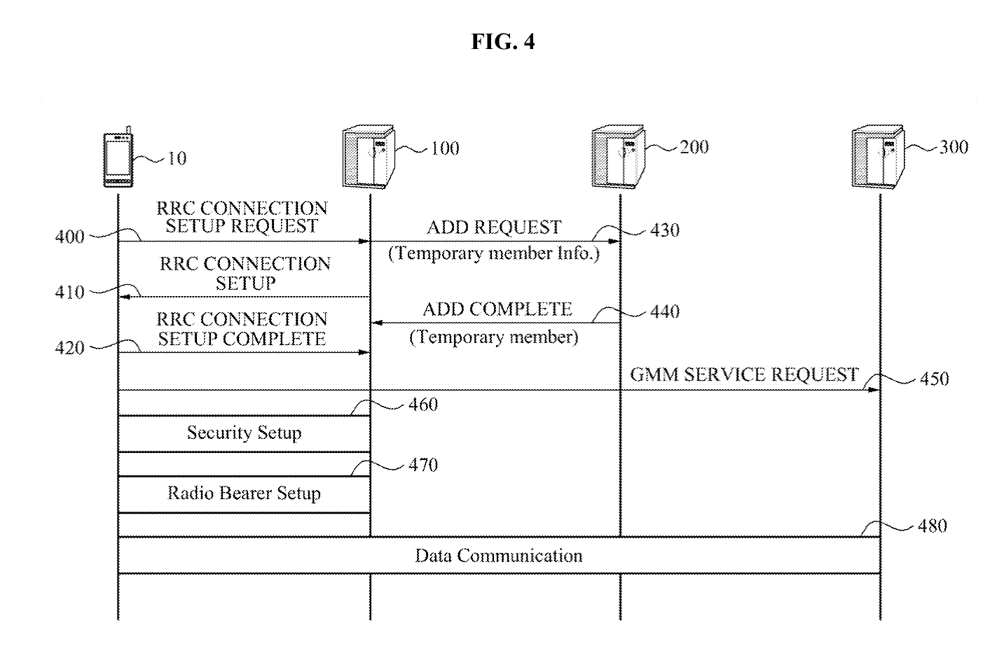

FIG. 4 is a flowchart illustrating a method in which the mobile terminal 10 is re-registered in a CSG in response to a request by the small base station 100 according to an exemplary embodiment of the present invention.

Before the network available time of the mobile terminal 10 expires, the small base station 100 may receive an RRC CONNECTION SETUP REQUEST message in operation 400.

The small base station 100 may transmit an RRC CONNECTION SETUP message to the mobile terminal 10 in response to the RRC CONNECTION SETUP REQUEST message in operation 410. Optionally, the small base station 100 may maintain the RRC connection setup as pending until the small base station 100 receives an ADD COMPLETE message as described below, and if the small base station 100 receives an ADD COMPLETE message, the small base station 100 may perform the operation 410.

The small base station 100 may receive an RRC CONNECTION SETUP COMPLETE message from the mobile terminal 10 in operation 420.

The small base station 100 may transmit, to the management server 200, an ADD REQUEST message requesting re-registration of the mobile terminal 10 in operation 430. The small base station 100 may allocate information about the mobile terminal 10 (Temporary member information) to the ADD REQUEST message and transmit the information to the management server 200. The information in the message includes a network available time remaining for the mobile terminal 10 to use. Accordingly, the small base station 100 may perform operation 430 after operation 400 and before operation 410 or after operation 420.

The management server 200 may then re-register the mobile terminal 10 in the CSG, and operate the second timer 230 to count down a network available time remaining for the mobile terminal 10 to use. Also, the management server 200 may enable the second memory unit 220 to store the information about the mobile terminal 10.

The small base station 100 may receive, from the management server 200, an ADD COMPLETE message indicating that the mobile terminal 10 was re-registered in the CSG in operation 440.

If the small base station 100 receives the ADD COMPLETE message, the mobile terminal 10 may be able to use a network and transmit a GMM SERVICE REQUEST message to the core node 300 in operation 450.

The small base station 100 may perform a security setup procedure with the mobile terminal 10 in operation 460, and may perform a radio bearer setup procedure in operation 470.

The mobile terminal 10 is then released from the PDP preservation state and enters a state in which the mobile terminal 10 is capable of data communication in operation 480.

After the operation 430, if the small base station 100 does not receive an ADD COMPLETE message within a specific time or receives a message indicating re-registration failure, the small base station 100 may report to the mobile terminal 10 that the mobile terminal 10 has been deleted from the CSG, and request re-registration.

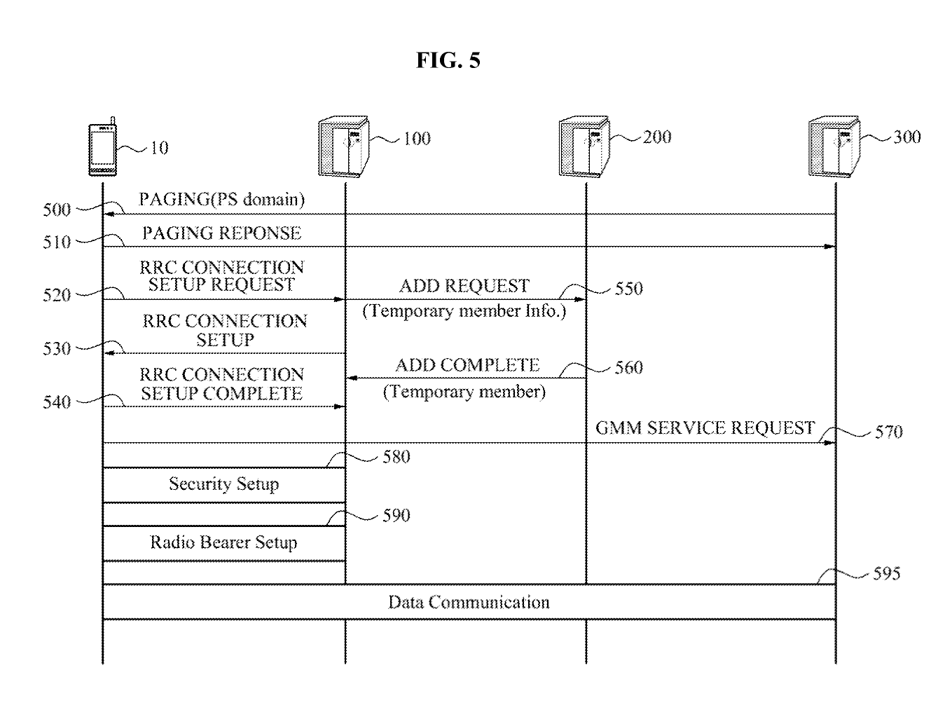

FIG. 5 is a flowchart illustrating a method in which the mobile terminal 10 is re-registered in a CSG in response to a request by the small base station 100 according to an exemplary embodiment of the present invention.

The core node 300 may transmit a PAGING REQUEST message to the mobile terminal 10 in operation 500. The PAGING REQUEST message may contain the content requesting connection to a packet-switching (PS) domain. Paging may occur, for example, if an external terminal (not shown) or the core node 300 intends to transmit data to the mobile terminal 10.

The mobile terminal 10 may transmit a PAGING RESPONSE message to the core node 300 in response to the PAGING REQUEST message in operation 510.

Subsequent operations 520 through 595 are the same as operations 400 through 480 mentioned above with reference to FIG. 4, and the detailed description thereof is not repeated.

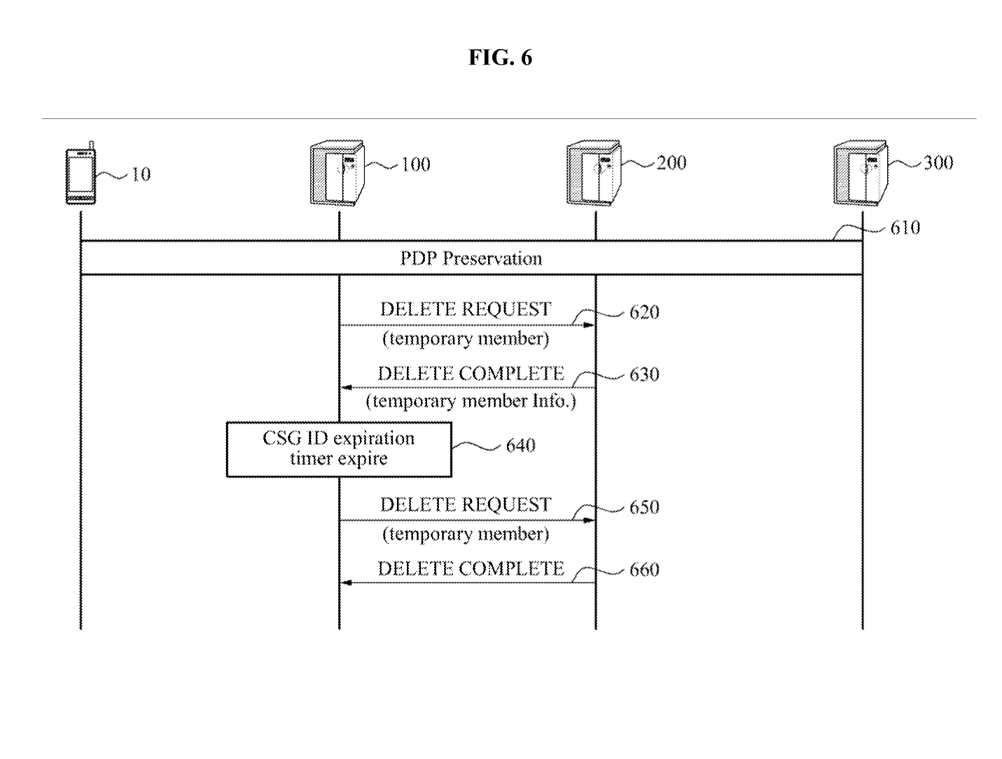

FIG. 6 is a flowchart illustrating a method in which the mobile terminal 10 is deleted from a CSG if a network available time of the mobile terminal expires, in response to a request by the small base station 100, according to an exemplary embodiment of the present invention.

The mobile terminal 10 is in a PDP preservation state in operation 610.

As the mobile terminal 10 is in a PDP preservation state, the small base station 100 may transmit, to the management server 200, a DELETE REQUEST message requesting temporary deletion of the mobile terminal 10 in operation 620.

The small base station 100 may receive a DELETE COMPLETE message from the management server 200 reporting that the mobile terminal 10 was temporarily deleted from the CSG in operation 630. Subsequent operations 620 and 630 are the same as operations 380 and 390 of FIG. 3, and the detailed description thereof is not repeated.

Next, the small base station 100 may determine how much of the network available time of the mobile terminal 10 is remaining in operation 640. The small base station 100 may check whether the network available time expired by operation of the first timer 130.

The small base station 100 may transmit, to the management server 200, a DELETE REQUEST message requesting complete deletion of the mobile terminal 10 in operation 650. The small base station 100 may allocate a reason for complete deletion of the mobile terminal 10 to the DELETE REQUEST message, and transmit the message.

The small base station 100 may receive a DELETE COMPLETE message from the management server 200 reporting that the mobile terminal 10 was completely deleted from the CSG in operation 660. In this instance, after the management server 200 deletes the mobile terminal 10 from the CSG, the management server 200 may report complete deletion of the mobile terminal 10 to the core node 300. Additionally, the management server 200 may report deletion of the mobile terminal 10 to the core node 300.

Even if the operation 660 is not performed, i.e., the small base station 100 does not receive a DELETE COMPLETE message, the small base station 100 may delete the mobile terminal from a management list stored in the first memory unit 140 as the mobile terminal 10 has already been temporarily deleted by the management server 200.

According to an exemplary embodiment of the present invention, the management server 200 may incorporated in the core node 300, and the above operations of FIG. 6 may be performed using a message requesting deletion or registration of a mobile terminal.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A small base station to manage a mobile terminal, the small base station comprising:
a communication unit to communicate with a server for managing a mobile terminal and a closed subscriber group (CSG) in which the mobile terminal is registered; and
a control unit to request the server to temporarily delete the mobile terminal from the CSG or to re-register the temporarily deleted mobile terminal in the CSG.

2. The small base station of claim 1, wherein the control unit requests the server to temporarily delete the mobile terminal if the mobile terminal does not use a network.

3. The small base station of claim 2, wherein the server temporarily deletes the mobile terminal from the CSG in response to the request of the control unit, and provides the communication unit with a network available time of the mobile terminal.

4. The small base station of claim 3, wherein the server enables a session created between the mobile terminal and an external node to be maintained if the mobile terminal is temporarily deleted from the CSG.

5. The small base station of claim 3, wherein the control unit counts down the network available time of the mobile terminal, and requests the server to delete the mobile terminal from the CSG if the network available time expires.

6. The small base station of claim 5, wherein the server deletes the mobile terminal from the CSG in response to the request of the control unit, and requests the external node to terminate the session between the mobile terminal and the external node.

7. The small base station of claim 5, wherein the control unit requests the server to re-register the mobile terminal in the CSG in response to a request for use of the network by the mobile terminal before the network available time expires.

8. The small base station of claim 7, wherein the control unit provides the server with the counted down network available time.

9. The small base station of claim 1, wherein the control unit requests the server to re-register the mobile terminal in the CSG if an external terminal or a core node has data to be transmitted to the mobile terminal.

10. The small base station of claim 1, wherein the server is a home subscriber server (HSS) or a core node.

11. A method for managing a mobile terminal by a small base station, the method comprising:
communicating with a server; and
requesting for a temporary deletion of the mobile terminal from a closed subscriber group (CSG) in which the mobile terminal is registered.

12. The method of claim 11, wherein the requesting for the temporary deletion includes requesting the server to temporarily delete the mobile terminal from the CSG if the mobile terminal does not use a network.

13. The method of claim 12, further comprising:
receiving a network available time of the mobile terminal from the server if the mobile terminal is temporarily deleted from the CSG in response to the request.

14. The method of claim 13, wherein the server enables a session created between the mobile terminal and an external node to be maintained if the mobile terminal is temporarily deleted from the CSG.

15. The method of claim 13, further comprising:
counting down the network available time of the mobile terminal; and
requesting the server to delete the mobile terminal from the CSG if the network available time expires.

16. The method of claim 15, wherein the server deletes the mobile terminal from the CSG and requests the external node to terminate the session between the mobile terminal and the external node.

17. The method of claim 15, further comprising:
requesting the server to re-register the temporarily deleted mobile terminal in the CSG in response to a request for use of the network by the mobile terminal before the network available time expires.

18. The method of claim 17, wherein the making a request for re-registration includes providing the server with the counted down network available time of the mobile terminal.

19. The method of claim 11, further comprising:
requesting the server to re-register the mobile terminal in the CSG if an external terminal or the server has data to be transmitted to the mobile terminal.

20. A closed subscriber group (CSG) management server, comprising:
a communication unit to communicate with a small base station of a small cell; and
a control unit to manage a CSG in which a mobile terminal in the small cell is registered, and to temporarily delete the mobile terminal registered in the CSG or to re-register the temporarily deleted mobile terminal in the CSG in response to a request from the small base station.

21. The CSG management server of claim 20, wherein the control unit temporarily deletes the mobile terminal from the CSG in response to the request from the small base station and provides the small base station with a network available time of the mobile terminal.

22. A mobile terminal, comprising:
a communication unit to communicate with a server for managing a closed subscriber group (CSG) in which the mobile terminal is registered; and
a control unit to request the server to temporarily delete the mobile terminal from the CSG or to re-register the temporarily deleted mobile terminal in the CSG.

23. The mobile terminal of claim 22, wherein the control unit counts down a network available time of the mobile terminal, and requests the server to delete the mobile terminal from the CSG if the network available time expires.

24. The mobile terminal of claim 23, wherein the server deletes the mobile terminal from the CSG in response to a request of the control unit, and terminates a session with the mobile terminal.

25. The mobile terminal of claim 23, wherein the control unit requests the server to re-register the mobile terminal in the CSG in response to a request for use of the network by the mobile terminal before the network available time expires.
